(19) United States
(12) Patent Application Publication
(10) Pub. No.: US 2024/0342979 A1
(43) Pub. Date: Oct. 17, 2024

(54) ADDITIVE MANUFACTURING USING CARBON NANOTUBES AND FORMULATION FOR USE IN SAME

(71) Applicant: ALTYMIK INC., Setauket, NY (US)

(72) Inventors: Daniel Slep, Setauket, NY (US); Fan Yang, South Setauket, NY (US)

(21) Appl. No.: 18/631,509

(22) Filed: Apr. 10, 2024

Related U.S. Application Data
(60) Provisional application No. 63/459,026, filed on Apr. 13, 2023.

(51) Int. Cl. B29C 64/112; B29C 64/209; B29C 64/255; B29K 507/04; B29L 31/34; B33Y 70/10; B33Y 80/00; C08K 3/04; C09D 11/38

(52) U.S. Cl. CPC B29C 64/112; B29C 64/209; B29C 64/255; B33Y 70/10; B33Y 80/00; C08K 3/041; C09D 11/38; B29K 2507/04; B29K 2995/0006; B29K 2995/0097; B29L 2031/3481

(57) ABSTRACT

An additive manufacturing process using an inkjet printer for forming at least one layer of a carbon nanotube-containing dielectric ink and at least one layer of a non-carbon nanotube-containing dielectric ink on a substrate includes the steps of containing the non-carbon nanotube-containing dielectric ink in a first vessel of the inkjet printer; supplying the non-carbon nanotube-containing dielectric ink to a first printer head of the inkjet printer from the first vessel; applying by the first printer head of the inkjet printer the non-carbon nanotube-containing dielectric ink to the substrate to form the at least one layer of the non-carbon nanotube-containing dielectric ink thereon; containing the carbon nanotube-containing dielectric ink in a second vessel of the inkjet printer; supplying the carbon nanotube-containing dielectric ink to a second printer head of the inkjet printer from the second vessel, wherein the first vessel is not in fluid communication with the second vessel to ensure that the non-carbon nanotube-containing dielectric ink contained in the first vessel is not mixed with the carbon nanotube-containing dielectric ink contained in the second vessel prior to the non-carbon nanotube-containing dielectric ink and the carbon nanotube-containing dielectric ink being supplied to the first printer head and the second printer head, respectively; and applying by the second printer head of the inkjet printer the carbon nanotube-containing dielectric ink to the substrate to form the at least one layer of the carbon nanotube-containing dielectric ink thereon.

### CROSS-REFERENCE TO RELATED APPLICATIONS

This application is related to U.S. Provisional Application Ser. No. 63/459,026, filed on Apr. 13, 2023, and titled “Additive Manufacturing Using Carbon Nanotubes And Formulation For Use With Same”, the disclosure of which is incorporated herein by reference and on which priority is hereby claimed.

### BACKGROUND OF THE INVENTION

### Field of the Invention

The present invention generally relates to additive manufacturing, and more specifically relates to 3D printing of objects using a modified form of an inkjet-type printer. Even more particularly, the present invention relates to liquid formulations using nano-composites used in additive manufacturing.

### Description of the Related Art

Additive manufacturing (AM), also known as 3D printing, has found many applications in recent years. Additive manufacturing is a process by which an object is defined three dimensionally by a series of layers. The object is then produced by creating/laying down material in rows one layer at a time.

There exist systems that use modified inkjet-type technology to “print” material onto a substrate, so building the object. A type of AM process utilizing inkjet printer heads is described, for example, in U.S. Pat. No. 5,555,176 to Menhennett, et al. Another type of AM process which extrudes a bead of material to build a part is described, for example, in U.S. Pat. No. 5,303,141 to Batchelder et al.

U.S. Pat. No. 10,428,196 (Daniel Slep, et al.), which issued on Oct. 1, 2019 and which is owned of record by Schmutz IP, 11c of Stony Brook, New York, the disclosure of which is incorporated herein by reference, discloses various curable liquid nano-composite formulations for use in additive manufacturing of objects.

It is also well known in the art to use carbon nanotubes in formulations for use in additive manufacturing, such as disclosed in U.S. Patent Application Publication No. 2021/0237509 (Bosnyak, et al.), which application was filed on Mar. 25, 2021 and which is owned of record by Molecular Rebar Design, 11c of Austin, Texas, the disclosure of which is incorporated herein by reference.

Carbon nanotubes exhibit many properties which when added to a liquid formulation used in additive manufacturing enhance the performance of the formulation and the results obtained through additive manufacturing. Generally, carbon nanotubes have high heat conductivity, electrical conductivity, mechanical and other properties. However, when dispersed in a liquid used in 3D printing, they tend to aggregate or “clump”, which can clog the printing heads used in typical inkjet-type 3D printers.

### OBJECTS AND SUMMARY OF THE INVENTION

It is an object of the present invention to provide a liquid formulation containing carbon nanotubes for use in additive manufacturing.

It is another object of the present invention to provide a method of additive manufacturing of objects using carbon nanotubes in a liquid formulation.

It is still another object of the present invention to provide a printer head arrangement for a 3D printer which may advantageously be used to apply a liquid formulation containing carbon nanotubes to an object being printed.

It is a further object of the present invention to provide a liquid formulation containing carbon nanotubes used in additive manufacturing which overcomes the inherent disadvantages of known formulations.

It is yet a further object of the present invention to provide dielectric ink formulations, one dielectric ink formulation containing nanotubes and the other dielectric ink formulation not containing nanotubes, the two dielectric ink formulations being compatible with each other.

It is still a further object of the present invention to provide a method of applying dielectric inks to a substrate, one dielectric ink containing nanotubes and the other dielectric ink not containing nanotubes.

In one form of the present invention, a liquid dielectric ink formulation containing carbon nanotubes (sometimes referred to herein as “CNT”) for use in additive manufacturing includes: N-vinyl-2pyrrolidone in a range of about 50 wt % to about 80 wt %; dipropyleneglycol diacrylate in a range of about 20 wt % to about 50 wt %; ethanol in a range of about 0 wt % to about 5 wt %; propylene glycol in a range of about 0 wt % to about 5 wt %; water in a range of about 0 wt % to about 5 wt %; polyvinylpyrrolidone in a range greater than 0 wt % and less than about 0.2 wt %; and carbon nanotubes in a range greater than 0 wt % and less than about 0.1 wt %. This carbon nanotube-containing dielectric ink (sometimes referred to herein as a “CNT dielectric ink”) is compatible and interacts with another dielectric ink which does not contain carbon nanotubes (sometimes referred to herein as a “non-CNT dielectric ink”), the two dielectric inks being applied separately, in layers, to an object, such as a substrate, formed or being formed through additive manufacturing using an inkjet-type printer.

The printer may include separate printer heads or a multi-channel printer head, each of the CNT dielectric ink and the non-CNT dielectric ink being contained in separate vessels feeding the printer head or heads.

In applying a dielectric to an object, such as a substrate, for example, in the formation of a printed circuit board or a semiconductor wafer, and in accordance with the present invention, a conductive ink is first applied to the substrate in a first layer on the substrate. The conductive ink is provided to the printer head of an inkjet-type printer from a first separate vessel. Then, the non-CNT dielectric ink is applied to the substrate in a second layer atop the conductive first layer, the non-CNT dielectric ink being provided to the printer head of the inkjet-type printer from a second separate vessel. Following the application of the non-CNT dielectric ink, a CNT (i.e., containing carbon nanotubes) dielectric ink is applied to the substrate in a third layer atop the second layer of the non-CNT (i.e., not containing carbon nanotubes) dielectric ink, the CNT dielectric ink being provided to the printer head of the inkjet-type printer from a third separate vessel. It should be noted that the order in which the CNT and non-CNT dielectric inks are applied to the substrate may be reversed. Thus, the CNT dielectric ink and the non-CNT dielectric ink remain separate from each other and are not premixed, prior to their application to the substrate. This methodology of the present invention has been found to avoid clumping or aggregation of the carbon nanotubes premixed with a dielectric ink and provided from a single vessel to the printer head before application of the ink on the substrate in a single layer.

The CNT dielectric ink in the third layer permeates to at least some degree the non-CNT dielectric ink in the second layer to provide at least partial intermixing of the two dielectric inks on the substrate and while in liquid form, which is an advantage of the present method and avoids the problem of clogging the printer head when the carbon nanotubes are premixed with the dielectric ink solution and provided to the printer head as is conventionally done. Preferably, each of the CNT dielectric ink and the non-CNT dielectric ink includes an acrylate monomer or polymer such that, when the two dielectric inks are cured by exposure of the substrate to UV (ultraviolet) or visible light, the dielectric inks undergo photopolymerization such that the acrylate monomers or polymers in the inks cross-link to form a unitary, hardened dielectric surface.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a block diagram of one form of a printer head arrangement of a 3D printer constructed in accordance with the present invention.

FIG. 2 is a block diagram of another form of a printer head arrangement of a 3D printer constructed in accordance with the present invention.

### DETAILED DESCRIPTION OF THE PREFERRED EMBODIMENTS

The present invention is particularly useful in additive printing of multi-layer printed circuit boards where conductive layers and dielectric layers are printed on a substrate. The dielectric ink formulation containing carbon nanotubes provides better structural and electrical properties for use in additive manufacturing than that achievable with known dielectric ink formulations. When carbon nanotubes are added to a known dielectric ink formulation, which is provided to an inkjet-type 3D printer, the carbon nanotubes tend to aggregate, or clump, in the ink prior to its passing through the printer head. The aggregated carbon nanotubes clog the printer head, requiring laborious effort and downtime to clean the printer and correct, if at all possible, any flaws in the printed object which may result from the printer head becoming clogged.

Another problem with using a complete solution containing the dielectric ink and carbon nanotubes in the same vessel before printing is that the carbon nanotubes are highly diluted in the ink solution and are thus insufficient in quantity to provide the desired effect.

More specifically, it has been found through experimentation that if a carbon nanotube dielectric ink, as is conventionally known, is singularly printed on a substrate, it does not provide the advantages of printing a dielectric ink containing carbon nanotubes separately as a layer or multiple layers in contact with a layer or multiple layers of a non-carbon nanotube-containing dielectric ink. The singularly-applied, conventional, carbon nanotube-containing dielectric ink disadvantageously provides a relatively low dielectric constant and poor mechanical properties. In effect, the method of additive manufacturing in accordance with the present invention essentially involves adding the carbon nanotubes to the dielectric ink through the printing process as opposed to adding the carbon nanotubes to the dielectric ink prior to printing.

Separate layers or multiple layers of a dielectric ink not containing carbon nanotubes and a dielectric ink containing carbon nanotubes are applied to an object (e.g., a substrate of a printed circuit board or semiconductor wafer). The CNT dielectric ink layer is in contact with the non-CNT dielectric layer so that, in effect, the CNT dielectric ink, in liquid form in one layer, mixes with the non-CNT dielectric ink, in liquid form in an adjacent layer, on the printed object or substrate and not in the printer head, and then hardened by photocuring.

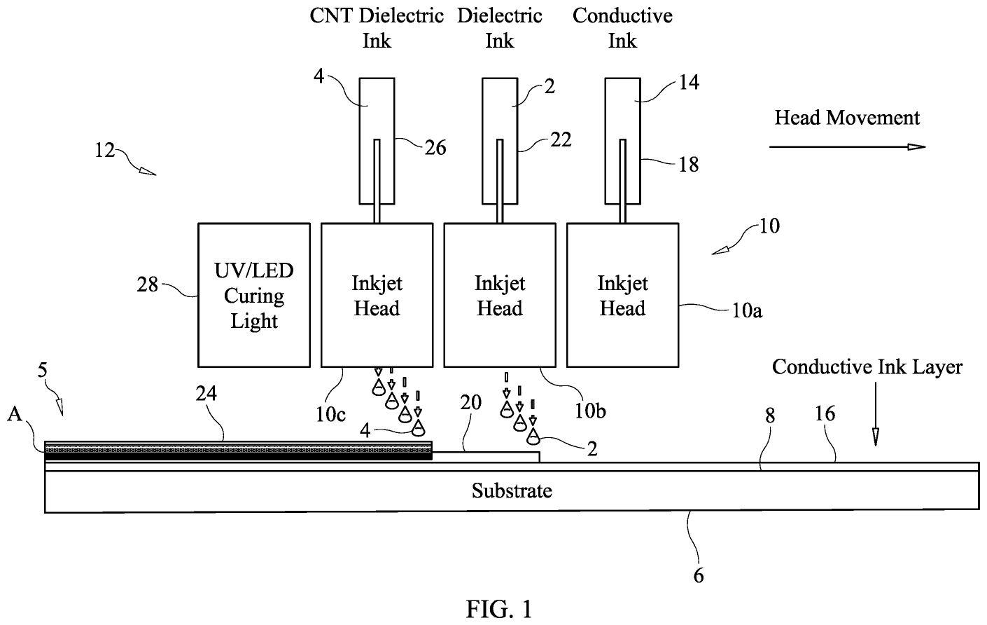

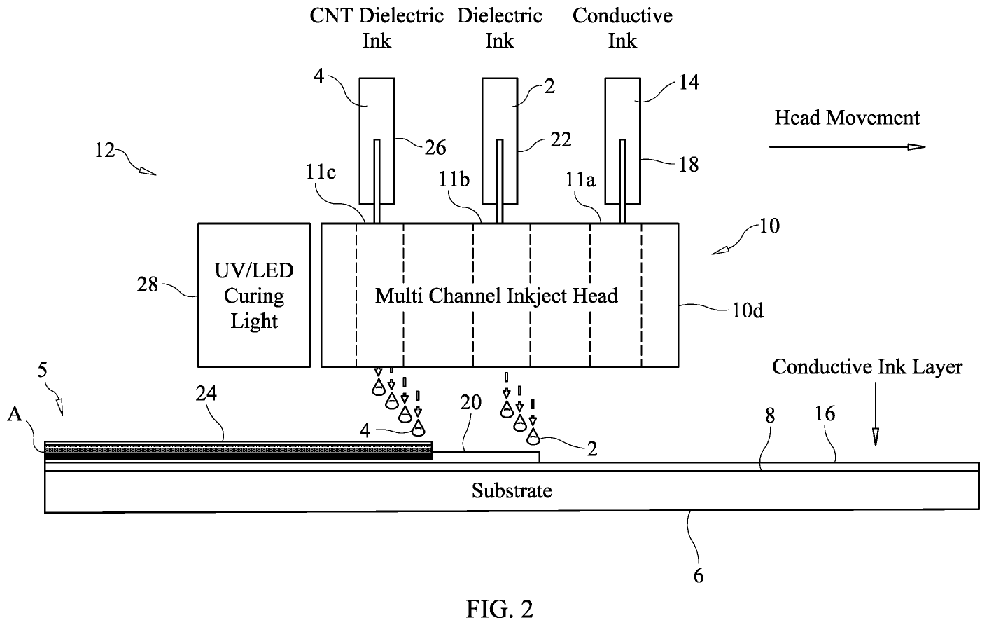

In accordance with the present invention, a preferred method of applying, separately, a liquid non-CNT dielectric ink 2 and a liquid CNT dielectric ink 4 to a substrate 6 to form liquid layers which at least partially intermix before curing in additive manufacturing of an object 5 is shown in FIGS. 1 and 2 of the drawings. In the example shown in FIGS. 1 and 2, the object 5 being printed is an electrical circuit board or a semiconductor wafer having a planar substrate 6 with a surface 8 exposed to the printer head or heads 10 of an inkjet-type printer 12 used for 3D printing. In this example, an electrically conductive ink 14 is deposited on the exposed surface 8 of the substrate 6 to form a first layer 16 on the substrate 6. The conductive ink 14, in liquid form, is provided to a first printer head 10a or to a first channel 11a of a multi-channel printer head 10d separately from the dielectric inks 2, 4 and from a separate first vessel 18 containing the conductive ink 14, as respectively shown in FIGS. 1 and 2.

A non-CNT dielectric ink 2 is then applied to the substrate 6 to form a second liquid layer 20 adjacent to the first layer 16 of conductive ink 14. The non-CNT dielectric ink 2 exhibits dielectric and other properties but without the enhanced properties achievable from using carbon nanotubes, as described previously. Preferably, the non-CNT dielectric ink 2 has a dielectric constant of between about 3 and about 4.5 to provide sufficient dielectric properties to the substrate 6. This second layer 20 of liquid non-CNT dielectric ink 2 is relatively thick (in relation to a layer of CNT dielectric ink 4), that is, preferably between about 5 microns and about 20 microns. The non-CNT dielectric ink 2, in liquid form, is provided to a second printer head 10b or a second channel 11b of the multi-channel printer head 10d of an inkjet-type printer 12, which second head 10b or second channel 11b is separate from the first head 10a or the first channel 11a used for the conductive ink 14, as respectively shown in FIGS. 1 and 2 of the drawings. The non-CNT dielectric ink 2 is provided to the second head 10b or second channel 11b from a separate second vessel 22 containing the non-CNT dielectric ink 2.

The CNT dielectric ink 4 is now applied to the substrate 6 to form a third liquid layer 24 adjacent to and in contact with the second layer 20 of non-CNT dielectric ink 2. The CNT dielectric ink 4, in liquid form, is provided to a third printer head 10c or a third channel 11c of a multi-channel printer head 10d of an inkjet-type printer 12, which third head 10c or third channel 11c is separate from the first and second heads 10a, 10b or the first and second channels 11a, 11b used for the conductive ink 14 and the non-CNT dielectric ink 2, as respectively shown in FIGS. 1 and 2 of the drawings. Furthermore, the CNT dielectric ink 4 is provided to the third head 10c or the third channel 11c from a separate third vessel 26 containing the CNT dielectric ink 4. This separation of the vessels 18, 22, 26 and printer heads 10a-10d or channels 11a-11c ensures that there is no intermixing of the CNT dielectric ink 4 and the non-CNT dielectric ink 2 prior to the application of the dielectric inks 2, 4 on the substrate 6.

Preferably, the CNT dielectric ink 4 has a dielectric constant of between about 3 and about 4.5. The thickness of the third layer 24 of liquid CNT dielectric ink 4 on the substrate 6 is relatively thin, when compared to the thickness of the second layer 20 of non-CNT dielectric ink 2, and is preferably less than about 3 microns in thickness and may be under about 1 micron in thickness.

Since each of the CNT dielectric ink 4 forming the third layer 24 and the non-CNT dielectric ink 2 forming the second layer 20 are still in liquid form when applied to the substrate 6, with the dielectric ink layers 20, 24 being adjacent to and in contact with each other, the CNT dielectric ink 4 will intermix at least partially with the non-CNT dielectric ink 2 while on the substrate 6, having not yet undergone photocuring. More specifically, the liquid CNT dielectric ink 4 of the third layer 24 is believed to at least interfacially mix with the liquid non-CNT dielectric ink 2 of the second layer 20 in a gradient manner, such as shown at A in FIGS. 1 and 2. This method of mixing the CNT dielectric ink 4 with the non-CNT dielectric ink 2 on the printed object 5 and not beforehand, such as in a single vessel or using a single printer head, as is conventionally done, avoids the problem of clogged printer heads caused by carbon nanotubes which have aggregated, forming clumps, in the liquid dielectric ink.

It should be noted that the CNT dielectric ink 4 may be applied to the substrate 6 before the non-CNT dielectric ink 2 is applied. As long as the CNT and non-CNT dielectric ink layers 24, 20 are in contact with each other, the order in which the CNT dielectric ink 4 and the non-CNT dielectric ink 2 are applied to the substrate 6 should be of little or no consequence. Such is advantageous in 3D printing due to the bi-directional motion of the printer head 10. Furthermore, although FIGS. 1 and 2 show only one layer 24 of CNT dielectric ink 4 and one layer 20 of non-CNT dielectric ink 2 being applied to the substrate 6 in this simplified example, it should be understood that multiple, interspersed layers of CNT dielectric ink 4 and non-CNT dielectric ink 2 may be applied to the substrate 6 and achieve the benefits of the method of the present invention.

After the CNT dielectric ink 4 and the non-CNT dielectric ink 2, each in single or multiple layers, or in multiple, interspersed layers (e.g., multiple adjacent CNT and non-CNT layers 24, 20), have been applied to the substrate 6, the CNT dielectric ink layer or layers 24 and the non-CNT dielectric ink layer or layers 20 are cured by exposing the substrate 6 and layers 20, 24 to UV (ultraviolet) light or visible light, for example, emitted by an array of light emitting diodes (LEDs) 28. It should be noted here that the conductive ink layer or layers 16 may have been previously printed and thermally cured in a separate process from that of the dielectric ink layers 20, 24, or are printed and thermally cured prior to or after the printing, formation and curing of one or more of the dielectric ink layers 20, 24. The thermally cured conductive ink layer or layers 16 may reside directly on the substrate 6, or may reside above or below a pair of adjacent non-CNT dielectric ink layer 20 and CNT dielectric ink layer 24 (the pair of dielectric ink layers 20, 24 residing in any order), or between adjacent pairs of multiple pairs of dielectric ink layers 20, 24. In a preferred method of curing the non-CNT dielectric layer 20 and the CNT dielectric layer 24, the substrate 6 is in optical communication with a source 28 of UV light or visible light, the light source 28 forming part of the inkjet-type 3D printer 12. Exposure to UV light or visible light cures and hardens the liquid dielectric ink layers 20, 24 on the substrate 6. Of course, it is envisioned to be within the scope of the present invention to use other methods of curing the conductive ink layer 16, the non-CNT dielectric ink layer 20 and the CNT dielectric ink layer 24 that are well known in the art, including thermally curing the dielectric ink layers 20, 24.

The CNT dielectric ink 4 should include one or more components which allow the CNT dielectric ink 4 to be curable, linkable and reactive with the non-CNT dielectric ink 2 so that the two dielectric inks 2, 4 are compatible, for example, a multi-site monomer. In a preferred form of the present invention, the CNT dielectric ink 4 is compatible with the non-CNT dielectric ink 2 due to each of the formulations of the CNT dielectric ink 4 and the non-CNT dielectric ink 2 including an acrylate monomer or polymer that is curable and wherein the acrylate monomer or polymer in the CNT dielectric ink 4 cross-links to the acrylate monomer or polymer in the non-CNT dielectric ink 2. Thus, each of the CNT dielectric ink 4 and the non-CNT dielectric ink 2 should have at least one compatible monomer or polymer, or the same monomer or polymer, to provide compatibility between the two dielectric inks 2, 4. Furthermore, the non-CNT and/or CNT dielectric inks 2, 4 can be a flexible dielectric or a rigid dielectric after curing.

In a first embodiment of the present invention, the CNT (i.e., with carbon nanotubes) dielectric ink 4 has the following formulation comprising, or consisting of, or consisting essentially of: N-vinyl-2pyrrolidone in a range of about 50 wt % to about 80 wt %; dipropyleneglycol diacrylate in a range of about 20 wt % to about 50 wt %; ethanol in a range of about 0 wt % to about 5 wt %; propylene glycol in a range of about 0 wt % to about 5 wt %; water in a range of about 0 wt % to about 5 wt %; polyvinylpyrrolidone in a range of greater than 0 wt % and less than about 0.2 wt %; and carbon nanotubes in a range of greater than 0 wt % and less than about 0.1 wt %.

In a second embodiment of the present invention, the non-CNT (i.e., without carbon nanotubes) dielectric ink 2 has the following formulation comprising, or consisting of, or consisting essentially of: dipropylene glycol diacrylate in a range of about 15 wt % to about 45 wt %; tripropylene glycol monomethyl ether acrylate in a range of about 15 wt % to about 45 wt %; N-vinyl-2pyrrolidone in a range of about 15 wt % to about 45 wt %; amine acrylate in a range of about 0 wt % to about 25 wt %; and Bis(2,4,6-trimethylbenzoyl) phenylphosphine oxide in a range of about 0 wt % to about 10 wt %, which acts as an initiator.

In a third embodiment of the present invention, the non-CNT (i.e., without carbon nanotubes) dielectric ink 2 has the following formulation comprising, or consisting of, or consisting essentially of: dipropylene glycol diacrylate in a range of about 15 wt % to about 45 wt %; tripropylene glycol monomethyl ether acrylate in a range of about 15 wt % to about 45 wt %; N-vinyl-2pyrrolidone in a range of about 15 wt % to about 45 wt %; amine acrylate in a range of about 0 wt % to about 10 wt %; a photoinitiator in a range of about 0 wt % to about 10 wt %; and 2,4,6-Trimethylbenzoyl diphenylphosphone oxide in a range of about 0 wt % to about 10 wt %, which acts as an initiator.

In a fourth embodiment of the present invention, the non-CNT (i.e., without carbon nanotubes) dielectric ink 2 has the following formulation comprising, or consisting of, or consisting essentially of: 1,6-Hexanediol diacrylate in a range of about 20 wt % to about 40 wt %; 2-2-Vinyloxyethoxy) ethyl acrylate in a range of about 10 wt % to about 30 wt %; isodecyl acrylate in a range of about 10 wt % to about 30 wt %; ethoxylated trimethyolpropane triacrylate in a range of about 0 wt % to about 20 wt %; amine acrylate in a range of about 0 wt % to about 20 wt %; 1-Hydroxycyclohexyl phenyl ketone in a range of about 0 wt % to about 10 wt %; and 2,4,6-Trimethylbenzoyl diphenylphosphone oxide in a range of about 0 wt % to about 10 wt %.

An additive manufacturing process, formulations of a carbon nanotube-containing dielectric ink and a non-carbon nanotube-containing dielectric ink used in an additive manufacturing process, an inkjet printer for use in an additive manufacturing process and an object formed using an additive manufacturing process will now be further described.

In accordance with one form of the present invention, an additive manufacturing process using an inkjet printer 12 for forming at least one layer 24 of a carbon nanotube-containing dielectric ink 4 and at least one layer 20 of a non-carbon nanotube-containing dielectric ink 2 directly or indirectly on an object 5 comprises the steps of: containing the non-carbon nanotube-containing dielectric ink 2 in a first vessel 22 of the inkjet printer 12; supplying the non-carbon nanotube-containing dielectric ink 2 to a first printer head 10b or to a first channel of a multi-channel printer head 10d of the inkjet printer 12 from the first vessel; applying by the first printer head 10b or the first channel of the multi-channel printer head 10d of the inkjet printer 12 the non-carbon nanotube-containing dielectric ink 2 directly or indirectly to the object 5 to form the at least one layer 20 of the non-carbon nanotube-containing dielectric ink 2 directly or indirectly thereon; containing the carbon nanotube-containing dielectric ink 4 in a second vessel 26 of the inkjet printer 12; supplying the carbon nanotube-containing dielectric ink 4 to a second printer head 10c or to a second channel of the multi-channel printer head 10d of the inkjet printer 12 from the second vessel, wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first printer head 10b or the first channel of the multi-channel printer head 10d and the second printer head 10c or the second channel of the multi-channel printer head 10d, respectively; and applying by the second printer head 10c or the second channel of the multi-channel printer head 10d of the inkjet printer 12 the carbon nanotube-containing dielectric ink 4 directly or indirectly to the object 5 to form the at least one layer 24 of the carbon nanotube-containing dielectric ink 4 directly or indirectly thereon, the at least one layer 24 of the carbon nanotube-containing dielectric ink 4 being at least partially in contact with the at least one layer 20 of the non-carbon nanotube-containing dielectric ink 2.

In the description of the invention provided herein, the phrase “directly or indirectly” means that any one of the conductive ink 14, the non-carbon nanotube-containing dielectric ink 2 and the carbon nanotube-containing dielectric ink 4 may be applied by their respective printer heads 10a-10c or channels 11a-11c of the multi-channel printer head 10d directly on the object 5 or substrate 6 to form an ink layer 16, 20, 24 directly on the object 5 or substrate 6, or indirectly on the object 5 or substrate 6 by applying the ink 14, 2, 4 to one or more ink layers 16, 20, 24 to form an ink layer 16, 20, 24 on, above or below the one or more ink layers 16, 20, 24 or in between ink layers 16, 20, 24.

In the additive manufacturing process described above, the dielectric constant of the non-carbon nanotube-containing dielectric ink 2 is between about 3 and about 4.5.

In the additive manufacturing process described above, the thickness of the at least one layer 20 of the non-carbon nanotube-containing dielectric ink 2 is between about 5 microns and about 20 microns.

In the additive manufacturing process described above, the dielectric constant of the carbon nanotube-containing dielectric ink 4 is between about 3 and about 4.5.

In the additive manufacturing process described above, the thickness of the at least one layer 24 of the carbon nanotube-containing dielectric ink 4 is less than about 3 microns.

In the additive manufacturing process described above, the thickness of the at least one layer 24 of the carbon nanotube-containing dielectric ink 4 is less than about 1 micron.

In the additive manufacturing process described above, the at least one layer 20 of the non-carbon nanotube-containing dielectric ink 2 resides directly or indirectly below the at least one layer 24 of the carbon nanotube-containing dielectric ink 4.

In the additive manufacturing process described above, the at least one layer 20 of the non-carbon nanotube-containing dielectric ink 2 resides directly or indirectly above the at least one layer 24 of the carbon nanotube-containing dielectric ink 4.

In the additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In the additive manufacturing process described above, the object 5 is one of a printed circuit board and a semiconductor wafer.

In accordance with another form of the present invention, an inkjet printer 12 used in an additive manufacturing process for applying a carbon nanotube-containing dielectric ink 4 and a non-carbon nanotube-containing dielectric ink 2 directly or indirectly to an object 5 to form respectively at least one layer 24 of the carbon nanotube-containing dielectric ink 4 and at least one layer 20 of the non-carbon nanotube-containing dielectric ink 2 directly or indirectly on the object 5 comprises: a first printer head 10b or a first channel 11b of a multi-channel printer head 10d for applying the non-carbon nanotube-containing dielectric ink 2 directly or indirectly to the object 5 to form the at least one layer 20 of the non-carbon nanotube-containing dielectric ink 2 directly or indirectly thereon; a first vessel 22 containing the non-carbon nanotube-containing dielectric ink 2, the first vessel 22 being in fluid communication with the first printer head 10b or with the first channel 11b of the multi-channel printer head 10d for supplying the non-carbon nanotube-containing dielectric ink 2 to the first printer head 10b or to the first channel 11b of the multi-channel printer head 10d; a second printer head 10c or a second channel 11c of the multi-channel printer head 10d for applying the carbon nanotube-containing dielectric ink 4 directly or indirectly to the object 5 to form the at least one layer 24 of the carbon nanotube-containing dielectric ink 4 directly or indirectly thereon; and a second vessel 26 containing the carbon nanotube-containing dielectric ink 4, the second vessel 26 being in fluid communication with the second printer head 10c or with the second channel 11c of the multi-channel printer head 10d for supplying the carbon nanotube-containing dielectric ink 4 to the second printer head 10c or the second channel 11c of the multi-channel printer head 10d; wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first printer head 10b or the first channel 11b of the multi-channel printer head 10d and the second printer head 10c or the second channel 11c of the multi-channel printer head 10d, respectively.

In the inkjet printer 12 used in an additive manufacturing process described above, the dielectric constant of the non-carbon nanotube-containing dielectric ink 2 is between about 3 and about 4.5.

In the inkjet printer 12 used in an additive manufacturing process described above, the thickness of the at least one layer 20 of the non-carbon nanotube-containing dielectric ink 2 is between about 5 microns and about 20 microns.

In the inkjet printer 12 used in an additive manufacturing process described above, the dielectric constant of the carbon nanotube-containing dielectric ink 4 is between about 3 and about 4.5.

In the inkjet printer 12 used in an additive manufacturing process described above, the thickness of the at least one layer 24 of the carbon nanotube-containing dielectric ink 4 is less than about 3 microns.

In the inkjet printer 12 used in an additive manufacturing process described above, the thickness of the at least one layer 24 of the carbon nanotube-containing dielectric ink 4 is less than about 1 micron.

In the inkjet printer 12 used in an additive manufacturing process described above, the at least one layer 20 of the non-carbon nanotube-containing dielectric ink 2 resides directly or indirectly below the at least one layer 24 of the carbon nanotube-containing dielectric ink 4.

In the inkjet printer 12 used in an additive manufacturing process described above, the at least one layer 20 of the non-carbon nanotube-containing dielectric ink 2 resides directly or indirectly above the at least one layer 24 of the carbon nanotube-containing dielectric ink 4.

In the inkjet printer 12 used in an additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the inkjet printer 12 used in an additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In the inkjet printer 12 used in an additive manufacturing process described above, the object 5 is one of a printed circuit board and a semiconductor wafer.

In accordance with another form of the present invention, an additive manufacturing process using an inkjet printer 12 for forming at least one layer 24 of a carbon nanotube-containing dielectric ink 4 and at least one layer 20 of a non-carbon nanotube-containing dielectric ink 2 directly or indirectly on a substrate 6 comprises the steps of: containing the non-carbon nanotube-containing dielectric ink 2 in a first vessel 22 of the inkjet printer 12; supplying the non-carbon nanotube-containing dielectric ink 2 to a first printer head 10b of the inkjet printer 12 from the first vessel; applying by the first printer head 10b of the inkjet printer 12 the non-carbon nanotube-containing dielectric ink 2 directly or indirectly to the substrate 6 to form the at least one layer 20 of the non-carbon nanotube-containing dielectric ink 2 directly or indirectly thereon; containing the carbon nanotube-containing dielectric ink 4 in a second vessel 26 of the inkjet printer 12; supplying the carbon nanotube-containing dielectric ink 4 to a second printer head 10c of the inkjet printer 12 from the second vessel, wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first printer head 10b and the second printer head, respectively; and applying by the second printer head 10c of the inkjet printer 12 the carbon nanotube-containing dielectric ink 4 directly or indirectly to the substrate 6 to form the at least one layer 24 of the carbon nanotube-containing dielectric ink 4 directly or indirectly thereon, the at least one layer 24 of the carbon nanotube-containing dielectric ink 4 being at least partially in contact with the at least one layer 20 of the non-carbon nanotube-containing dielectric ink 2.

In the additive manufacturing process described above, the dielectric constant of the non-carbon nanotube-containing dielectric ink 2 is between about 3 and about 4.5.

In the additive manufacturing process described above, the thickness of the at least one layer 20 of the non-carbon nanotube-containing dielectric ink 2 is between about 5 microns and about 20 microns.

In the additive manufacturing process described above, the dielectric constant of the carbon nanotube-containing dielectric ink 4 is between about 3 and about 4.5.

In the additive manufacturing process described above, the thickness of the at least one layer 24 of the carbon nanotube-containing dielectric ink 4 is less than about 3 microns.

In the additive manufacturing process described above, the thickness of the at least one layer 24 of the carbon nanotube-containing dielectric ink 4 is less than about 1 micron.

In the additive manufacturing process described above, the at least one layer 20 of the non-carbon nanotube-containing dielectric ink 2 resides directly or indirectly below the at least one layer 24 of the carbon nanotube-containing dielectric ink 4.

In the additive manufacturing process described above, the at least one layer 20 of the non-carbon nanotube-containing dielectric ink 2 resides directly or indirectly above the at least one layer 24 of the carbon nanotube-containing dielectric ink 4.

In the additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In accordance with another form of the present invention, an additive manufacturing process using an inkjet printer 12 for forming at least one layer 24 of a carbon nanotube-containing dielectric ink 4 and at least one layer 20 of a non-carbon nanotube-containing dielectric ink 2 directly or indirectly on a substrate 6 comprises the steps of: containing the non-carbon nanotube-containing dielectric ink 2 in a first vessel 22 of the inkjet printer 12; supplying the non-carbon nanotube-containing dielectric ink 2 to a first channel 11b of a multi-channel printer head 10d of the inkjet printer 12 from the first vessel; applying by the first channel 11b of the multi-channel printer head 10d of the inkjet printer 12 the non-carbon nanotube-containing dielectric ink 2 directly or indirectly to the substrate 6 to form the at least one layer 20 of the non-carbon nanotube-containing dielectric ink 2 directly or indirectly thereon; containing the carbon nanotube-containing dielectric ink 4 in a second vessel 26 of the inkjet printer 12; supplying the carbon nanotube-containing dielectric ink 4 to a second channel 11c of the multi-channel printer head 10d of the inkjet printer 12 from the second vessel, wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first channel 11b and the second channel 11c of the multi-channel printer head 10d, respectively; and applying by the second channel 11c of the multi-channel printer head 10d of the inkjet printer 12 the carbon nanotube-containing dielectric ink 4 directly or indirectly to the substrate 6 to form the at least one layer 24 of the carbon nanotube-containing dielectric ink 4 directly or indirectly thereon, the at least one layer 24 of the carbon nanotube-containing dielectric ink 4 being at least partially in contact with the at least one layer 20 of the non-carbon nanotube-containing dielectric ink 2.

In the additive manufacturing process described above, the dielectric constant of the non-carbon nanotube-containing dielectric ink 2 is between about 3 and about 4.5.

In the additive manufacturing process described above, the thickness of the at least one layer 20 of the non-carbon nanotube-containing dielectric ink 2 is between about 5 microns and about 20 microns.

In the additive manufacturing process described above, the dielectric constant of the carbon nanotube-containing dielectric ink 4 is between about 3 and about 4.5.

In the additive manufacturing process described above, the thickness of the at least one layer 24 of the carbon nanotube-containing dielectric ink 4 is less than about 3 microns.

In the additive manufacturing process described above, the thickness of the at least one layer 24 of the carbon nanotube-containing dielectric ink 4 is less than about 1 micron.

In the additive manufacturing process described above, the at least one layer 20 of the non-carbon nanotube-containing dielectric ink 2 resides directly or indirectly below the at least one layer 24 of the carbon nanotube-containing dielectric ink 4.

In the additive manufacturing process described above, the at least one layer 20 of the non-carbon nanotube-containing dielectric ink 2 resides directly or indirectly above the at least one layer 24 of the carbon nanotube-containing dielectric ink 4.

In the additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In accordance with another form of the present invention, an additive manufacturing process using an inkjet printer 12 for forming at least one layer 24 of a carbon nanotube-containing dielectric ink 4, at least one layer 20 of a non-carbon nanotube-containing dielectric ink 2 and at least one layer 16 of a conductive ink 14 directly or indirectly on a substrate 6 comprises the steps of: containing the conductive ink 14 in a first vessel 18 of the inkjet printer 12; supplying the conductive ink 14 to a first printer head 10a of the inkjet printer 12 from the first vessel; applying by the first printer head 10a of the inkjet printer 12 the conductive ink 14 directly or indirectly to the substrate 6 to form the at least one layer 16 of the conductive ink 14 directly or indirectly thereon; containing the non-carbon nanotube-containing dielectric ink 2 in a second vessel 22 of the inkjet printer 12; supplying the non-carbon nanotube-containing dielectric ink 2 to a second printer head 10b of the inkjet printer 12 from the second vessel; applying by the second printer head 10b of the inkjet printer 12 the non-carbon nanotube-containing dielectric ink 2 directly or indirectly to the substrate 6 to form the at least one layer 20 of the non-carbon nanotube-containing dielectric ink 2 directly or indirectly thereon; containing the carbon nanotube-containing dielectric ink 4 in a third vessel 26 of the inkjet printer 12; supplying the carbon nanotube-containing dielectric ink 4 to a third printer head 10c of the inkjet printer 12 from the third vessel, wherein the second vessel 22 is not in fluid communication with the third vessel 26 to ensure that the non-carbon nanotube-containing dielectric ink 2 contained in the second vessel 22 is not mixed with the carbon nanotube-containing dielectric ink 4 contained in the third vessel 26 prior to the non-carbon nanotube-containing dielectric ink 2 and the carbon nanotube-containing dielectric ink 4 being supplied to the second printer head 10b and the third printer head, respectively; and applying by the third printer head 10c of the inkjet printer 12 the carbon nanotube-containing dielectric ink 4 directly or indirectly to the substrate 6 to form the at least one layer 24 of the carbon nanotube-containing dielectric ink 4 directly or indirectly thereon, the at least one layer 24 of the carbon nanotube-containing dielectric ink 4 being at least partially in contact with the at least one layer 20 of the non-carbon nanotube-containing dielectric ink 2.

In the additive manufacturing process described above, the dielectric constant of the non-carbon nanotube-containing dielectric ink 2 is between about 3 and about 4.5.

In the additive manufacturing process described above, the thickness of the at least one layer 20 of the non-carbon nanotube-containing dielectric ink 2 is between about 5 microns and about 20 microns.

In the additive manufacturing process described above, the dielectric constant of the carbon nanotube-containing dielectric ink 4 is between about 3 and about 4.5.

In the additive manufacturing process described above, the thickness of the at least one layer 24 of the carbon nanotube-containing dielectric ink 4 is less than about 3 microns.

In the additive manufacturing process described above, the thickness of the at least one layer 24 of the carbon nanotube-containing dielectric ink 4 is less than about 1 micron.

In the additive manufacturing process described above, the at least one layer 20 of the non-carbon nanotube-containing dielectric ink 2 resides directly or indirectly below the at least one layer 24 of the carbon nanotube-containing dielectric ink 4.

In the additive manufacturing process described above, the at least one layer 20 of the non-carbon nanotube-containing dielectric ink 2 resides directly or indirectly above the at least one layer 24 of the carbon nanotube-containing dielectric ink 4.

In the additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In accordance with another form of the present invention, an additive manufacturing process using an inkjet printer 12 for forming at least one layer 24 of a carbon nanotube-containing dielectric ink 4, at least one layer 20 of a non-carbon nanotube-containing dielectric ink 2 and at least one layer 16 of a conductive ink 14 directly or indirectly on a substrate 6 comprises the steps of: containing the conductive ink 14 in a first vessel 18 of the inkjet printer 12; supplying the conductive ink 14 to a first channel 11a of a multi-channel printer head 10d of the inkjet printer 12 from the first vessel; applying by the first channel 11a of the multi-channel printer head 10d of the inkjet printer 12 the conductive ink 14 directly or indirectly to the substrate 6 to form the at least one layer 16 of the conductive ink 14 directly or indirectly thereon; containing the non-carbon nanotube-containing dielectric ink 2 in a second vessel 22 of the inkjet printer 12; supplying the non-carbon nanotube-containing dielectric ink 2 to a second channel 11b of the multi-channel printer head 10d of the inkjet printer 12 from the second vessel; applying by the second channel 11b of the multi-channel printer head 10d of the inkjet printer 12 the non-carbon nanotube-containing dielectric ink 2 directly or indirectly to the substrate 6 to form the at least one layer 20 of the non-carbon nanotube-containing dielectric ink 2 directly or indirectly thereon; containing the carbon nanotube-containing dielectric ink 4 in a third vessel 26 of the inkjet printer 12; supplying the carbon nanotube-containing dielectric ink 4 to a third channel 11c of the multi-channel printer head 10d of the inkjet printer 12 from the third vessel, wherein the second vessel 22 is not in fluid communication with the third vessel 26 to ensure that the non-carbon nanotube-containing dielectric ink 2 contained in the second vessel 22 is not mixed with the carbon nanotube-containing dielectric ink 4 contained in the third vessel 26 prior to the non-carbon nanotube-containing dielectric ink 2 and the carbon nanotube-containing dielectric ink 4 being supplied to the second channel 11b and the third channel 11c of the multi-channel printer head 10d, respectively; and applying by the third channel 11c of the multi-channel printer head 10d of the inkjet printer 12 the carbon nanotube-containing dielectric ink 4 directly or indirectly to the substrate 6 to form the at least one layer 24 of the carbon nanotube-containing dielectric ink 4 directly or indirectly thereon, the at least one layer 24 of the carbon nanotube-containing dielectric ink 4 being at least partially in contact with the at least one layer 20 of the non-carbon nanotube-containing dielectric ink 2.

In the additive manufacturing process described above, the dielectric constant of the non-carbon nanotube-containing dielectric ink 2 is between about 3 and about 4.5.

In the additive manufacturing process described above, the thickness of the at least one layer 20 of the non-carbon nanotube-containing dielectric ink 2 is between about 5 microns and about 20 microns.

In the additive manufacturing process described above, the dielectric constant of the carbon nanotube-containing dielectric ink 4 is between about 3 and about 4.5.

In the additive manufacturing process described above, the thickness of the at least one layer 24 of the carbon nanotube-containing dielectric ink 4 is less than about 3 microns.

In the additive manufacturing process described above, the thickness of the at least one layer 24 of the carbon nanotube-containing dielectric ink 4 is less than about 1 micron.

In the additive manufacturing process described above, the at least one layer 20 of the non-carbon nanotube-containing dielectric ink 2 resides directly or indirectly below the at least one layer 24 of the carbon nanotube-containing dielectric ink 4.

In the additive manufacturing process described above, the at least one layer 20 of the non-carbon nanotube-containing dielectric ink 2 resides directly or indirectly above the at least one layer 24 of the carbon nanotube-containing dielectric ink 4.

In the additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In accordance with another form of the present invention, an inkjet printer 12 used in an additive manufacturing process for applying a carbon nanotube-containing dielectric ink 4 and a non-carbon nanotube-containing dielectric ink 2 directly or indirectly to a substrate 6 to form respectively at least one layer 24 of the carbon nanotube-containing dielectric ink 4 and at least one layer 20 of the non-carbon nanotube-containing dielectric ink 2 directly or indirectly on the substrate 6 comprises: a first printer head 10b for applying the non-carbon nanotube-containing dielectric ink 2 directly or indirectly to the substrate 6 to form the at least one layer 20 of the non-carbon nanotube-containing dielectric ink 2 directly or indirectly thereon; a first vessel 22 containing the non-carbon nanotube-containing dielectric ink 2, the first vessel 22 being in fluid communication with the first printer head 10b for supplying the non-carbon nanotube-containing dielectric ink 2 to the first printer head; a second printer head 10c for applying the carbon nanotube-containing dielectric ink 4 directly or indirectly to the substrate 6 to form the at least one layer 24 of the carbon nanotube-containing dielectric ink 4 directly or indirectly thereon; and a second vessel 26 containing the carbon nanotube-containing dielectric ink 4, the second vessel 26 being in fluid communication with the second printer head 10c for supplying the carbon nanotube-containing dielectric ink 4 to the second printer head; wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first printer head 10b and the second printer head, respectively.

In accordance with another form of the present invention, an inkjet printer 12 used in an additive manufacturing process for applying a carbon nanotube-containing dielectric ink 4 and a non-carbon nanotube-containing dielectric ink 2 directly or indirectly to a substrate 6 to form respectively at least one layer 24 of the carbon nanotube-containing dielectric ink 4 and at least one layer 20 of the non-carbon nanotube-containing dielectric ink 2 directly or indirectly on the substrate 6 comprises: a first channel 11b of a multi-channel printer head 10d for applying the non-carbon nanotube-containing dielectric ink 2 directly or indirectly to the substrate 6 to form the at least one layer 20 of the non-carbon nanotube-containing dielectric ink 2 directly or indirectly thereon; a first vessel 22 containing the non-carbon nanotube-containing dielectric ink 2, the first vessel 22 being in fluid communication with the first channel 11b of the multi-channel printer head 10d for supplying the non-carbon nanotube-containing dielectric ink 2 to the first printer head; a second channel 11c of the multi-channel printer head 10d for applying the carbon nanotube-containing dielectric ink 4 directly or indirectly to the substrate 6 to form the at least one layer 24 of the carbon nanotube-containing dielectric ink 4 directly or indirectly thereon; and a second vessel 26 containing the carbon nanotube-containing dielectric ink 4, the second vessel 26 being in fluid communication with the second channel 11c of the multi-channel printer head 10d for supplying the carbon nanotube-containing dielectric ink 4 to the second printer head; wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first channel 11b and the second channel 11c of the multi-channel printer head 10d, respectively.

In accordance with another form of the present invention, an inkjet printer 12 used in an additive manufacturing process for applying a carbon nanotube-containing dielectric ink 4, a non-carbon nanotube-containing dielectric ink 2 and a conductive ink 14 directly or indirectly to a substrate 6 to form respectively at least one layer 24 of the carbon nanotube-containing dielectric ink 4, at least one layer 20 of the non-carbon nanotube-containing dielectric ink 2 and at least one layer 16 of the conductive ink 14 directly or indirectly on the substrate 6 comprises: a first printer head 10a for applying the conductive ink 14 directly or indirectly to the substrate 6 to form the at least one layer 16 of the conductive ink 14 directly or indirectly thereon; a first vessel 18 containing the conductive ink, the first vessel 18 being in fluid communication with the first printer head 10a for supplying the conductive ink 14 to the first printer head; a second printer head 10b for applying the non-carbon nanotube-containing dielectric ink 2 directly or indirectly to the substrate 6 to form the at least one layer 20 of the non-carbon nanotube-containing dielectric ink 2 directly or indirectly thereon; a second vessel 22 containing the non-carbon nanotube-containing dielectric ink 2, the second vessel 22 being in fluid communication with the second printer head 10b for supplying the non-carbon nanotube-containing dielectric ink 2 to the second printer head; a third printer head 10c for applying the carbon nanotube-containing dielectric ink 4 directly or indirectly to the substrate 6 to form the at least one layer 24 of the carbon nanotube-containing dielectric ink 4 directly or indirectly thereon; and a third vessel 26 containing the carbon nanotube-containing dielectric ink 4, the third vessel 26 being in fluid communication with the third printer head 10c for supplying the carbon nanotube-containing dielectric ink 4 to the third printer head; wherein the second vessel 22 is not in fluid communication with the third vessel 26 to ensure that the non-carbon nanotube-containing dielectric ink 2 contained in the second vessel 22 is not mixed with the carbon nanotube-containing dielectric ink 4 contained in the third vessel 26 prior to the non-carbon nanotube-containing dielectric ink 2 and the carbon nanotube-containing dielectric ink 4 being supplied to the second printer head 10b and the third printer head, respectively.

In accordance with another form of the present invention, an inkjet printer 12 used in an additive manufacturing process for applying a carbon nanotube-containing dielectric ink 4, a non-carbon nanotube-containing dielectric ink 2 and a conductive ink 14 directly or indirectly to a substrate 6 to form respectively at least one layer 24 of the carbon nanotube-containing dielectric ink 4, at least one layer 20 of the non-carbon nanotube-containing dielectric ink 2 and at least one layer 16 of the conductive ink 14 directly or indirectly on the substrate 6 comprises: a first channel 11a of a multi-channel printer head 10d for applying the conductive ink 14 directly or indirectly to the substrate 6 to form the at least one layer 16 of the conductive ink 14 directly or indirectly thereon; a first vessel 18 containing the conductive ink, the first vessel 18 being in fluid communication with the first channel 11a of the multi-channel printer head 10d for supplying the conductive ink 14 to the first printer head; a second channel 11b of the multi-channel printer head 10d for applying the non-carbon nanotube-containing dielectric ink 2 directly or indirectly to the substrate 6 to form the at least one layer 20 of the non-carbon nanotube-containing dielectric ink 2 directly or indirectly thereon; a second vessel 22 containing the non-carbon nanotube-containing dielectric ink 2, the second vessel 22 being in fluid communication with the second channel 11b of the multi-channel printer head 10d for supplying the non-carbon nanotube-containing dielectric ink 2 to the second printer head; a third channel 11c of the multi-channel printer head 10d for applying the carbon nanotube-containing dielectric ink 4 directly or indirectly to the substrate 6 to form the at least one layer 24 of the carbon nanotube-containing dielectric ink 4 directly or indirectly thereon; and a third vessel 26 containing the carbon nanotube-containing dielectric ink 4, the third vessel 26 being in fluid communication with the third channel 11c of the multi-channel printer head 10d for supplying the carbon nanotube-containing dielectric ink 4 to the third printer head; wherein the second vessel 22 is not in fluid communication with the third vessel 26 to ensure that the non-carbon nanotube-containing dielectric ink 2 contained in the second vessel 22 is not mixed with the carbon nanotube-containing dielectric ink 4 contained in the third vessel 26 prior to the non-carbon nanotube-containing dielectric ink 2 and the carbon nanotube-containing dielectric ink 4 being supplied to the second channel 11b and the third channel 11c of the multi-channel printer head 10d, respectively.

In accordance with another form of the present invention, an object 5 formed by an additive manufacturing process using an inkjet printer 12 is provided, the object 5 comprising: a substrate 6; at least one layer 20 of a non-carbon nanotube-containing dielectric ink 2 disposed directly or indirectly on the substrate 6, the at least one layer 20 of the non-carbon nanotube-containing dielectric ink 2 being formed directly or indirectly on the substrate 6 by the following steps: containing the non-carbon nanotube-containing dielectric ink 2 in a first vessel 22 of the inkjet printer 12; supplying the non-carbon nanotube-containing dielectric ink 2 to a first printer head 10b of the inkjet printer 12 from the first vessel; and applying by the first printer head 10b of the inkjet printer 12 the non-carbon nanotube-containing dielectric ink 2 directly or indirectly to the substrate 6 to form the at least one layer 20 of the non-carbon nanotube-containing dielectric ink 2 directly or indirectly thereon; and at least one layer 24 of a carbon nanotube-containing dielectric ink 4 disposed directly or indirectly on the substrate 6, the at least one layer 24 of the carbon nanotube-containing dielectric ink 4 being at least partially in contact with the at least one layer 20 of the non-carbon nanotube-containing dielectric ink 2, the at least one layer 24 of the carbon nanotube-containing dielectric ink 4 being formed directly or indirectly on the substrate 6 by the following steps: containing the carbon nanotube-containing dielectric ink 4 in a second vessel 26 of the inkjet printer 12; supplying the carbon nanotube-containing dielectric ink 4 to a second printer head 10c of the inkjet printer 12 from the second vessel, wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first printer head 10b and the second printer head, respectively; and applying by the second printer head 10c of the inkjet printer 12 the carbon nanotube-containing dielectric ink 4 directly or indirectly to the substrate 6 to form the at least one layer 24 of the carbon nanotube-containing dielectric ink 4 directly or indirectly thereon.

In the object 5 formed by an additive manufacturing process described above, the dielectric constant of the non-carbon nanotube-containing dielectric ink 2 is between about 3 and about 4.5.

In the object 5 formed by an additive manufacturing process described above, the thickness of the at least one layer 20 of the non-carbon nanotube-containing dielectric ink 2 is between about 5 microns and about 20 microns.

In the object 5 formed by an additive manufacturing process described above, the dielectric constant of the carbon nanotube-containing dielectric ink 4 is between about 3 and about 4.5.

In the object 5 formed by an additive manufacturing process described above, the thickness of the at least one layer 24 of the carbon nanotube-containing dielectric ink 4 is less than about 3 microns.

In the object 5 formed by an additive manufacturing process described above, the thickness of the at least one layer 24 of the carbon nanotube-containing dielectric ink 4 is less than about 1 micron.

In the object 5 formed by an additive manufacturing process described above, the at least one layer 20 of the non-carbon nanotube-containing dielectric ink 2 resides directly or indirectly below the at least one layer 24 of the carbon nanotube-containing dielectric ink 4.

In the object 5 formed by an additive manufacturing process described above, the at least one layer 20 of the non-carbon nanotube-containing dielectric ink 2 resides directly or indirectly above the at least one layer 24 of the carbon nanotube-containing dielectric ink 4.

In the object 5 formed by an additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the object 5 formed by an additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In the object 5 formed by an additive manufacturing process described above, the object 5 is one of a printed circuit board and a semiconductor wafer.

In accordance with another form of the present invention, an object 5 formed by an additive manufacturing process using an inkjet printer 12 is provided, the object 5 comprising: a substrate 6; at least one layer 20 of a non-carbon nanotube-containing dielectric ink 2 disposed directly or indirectly on the substrate 6, the at least one layer 20 of the non-carbon nanotube-containing dielectric ink 2 being formed directly or indirectly on the substrate 6 by the following steps: containing the non-carbon nanotube-containing dielectric ink 2 in a first vessel 22 of the inkjet printer 12; supplying the non-carbon nanotube-containing dielectric ink 2 to a first channel 11b of a multi-channel printer head 10d of the inkjet printer 12 from the first vessel; and applying by the first channel 11b of the multi-channel printer head 10d of the inkjet printer 12 the non-carbon nanotube-containing dielectric ink 2 directly or indirectly to the substrate 6 to form the at least one layer 20 of the non-carbon nanotube-containing dielectric ink 2 directly or indirectly thereon; and at least one layer 24 of a carbon nanotube-containing dielectric ink 4 disposed directly or indirectly on the substrate 6, the at least one layer 24 of the carbon nanotube-containing dielectric ink 4 being at least partially in contact with the at least one layer 20 of the non-carbon nanotube-containing dielectric ink 2, the at least one layer 24 of the carbon nanotube-containing dielectric ink 4 being formed directly or indirectly on the substrate 6 by the following steps: containing the carbon nanotube-containing dielectric ink 4 in a second vessel 26 of the inkjet printer 12; supplying the carbon nanotube-containing dielectric ink 4 to a second channel 11c of the multi-channel printer head 10d of the inkjet printer 12 from the second vessel, wherein the first vessel 22 is not in fluid communication with the second vessel 26 to ensure that the non-carbon nanotube-containing dielectric ink 2 contained in the first vessel 22 is not mixed with the carbon nanotube-containing dielectric ink 4 contained in the second vessel 26 prior to the non-carbon nanotube-containing dielectric ink 2 and the carbon nanotube-containing dielectric ink 4 being supplied to the first channel 11b and the second channel 11c of the multi-channel printer head 10d, respectively; and applying by the second channel 11c of the multi-channel printer head 10d of the inkjet printer 12 the carbon nanotube-containing dielectric ink 4 directly or indirectly to the substrate 6 to form the at least one layer 24 of the carbon nanotube-containing dielectric ink 4 directly or indirectly thereon.

In the object 5 formed by an additive manufacturing process described above, the dielectric constant of the non-carbon nanotube-containing dielectric ink 2 is between about 3 and about 4.5.

In the object 5 formed by an additive manufacturing process described above, the thickness of the at least one layer 20 of the non-carbon nanotube-containing dielectric ink 2 is between about 5 microns and about 20 microns.

In the object 5 formed by an additive manufacturing process described above, the dielectric constant of the carbon nanotube-containing dielectric ink 4 is between about 3 and about 4.5.

In the object 5 formed by an additive manufacturing process described above, the thickness of the at least one layer 24 of the carbon nanotube-containing dielectric ink 4 is less than about 3 microns.

In the object 5 formed by an additive manufacturing process described above, the thickness of the at least one layer 24 of the carbon nanotube-containing dielectric ink 4 is less than about 1 micron.

In the object 5 formed by an additive manufacturing process described above, the at least one layer 20 of the non-carbon nanotube-containing dielectric ink 2 resides directly or indirectly below the at least one layer 24 of the carbon nanotube-containing dielectric ink 4.

In the object 5 formed by an additive manufacturing process described above, the at least one layer 20 of the non-carbon nanotube-containing dielectric ink 2 resides directly or indirectly above the at least one layer 24 of the carbon nanotube-containing dielectric ink 4.

In the object 5 formed by an additive manufacturing process described above, the at least one layer 20 of the non-carbon nanotube-containing dielectric ink 2 includes more than one layer 20 of the non-carbon nanotube-containing dielectric ink 2, at least one layer of the more than one layer 20 of the non-carbon nanotube-containing dielectric ink 2 being at least partially in contact with the at least one layer 24 of the carbon nanotube-containing dielectric ink 4.

In the object 5 formed by an additive manufacturing process described above, the at least one layer 24 of the carbon nanotube-containing dielectric ink 4 includes more than one layer 24 of the carbon nanotube-containing dielectric ink 4, at least one layer of the more than one layer 24 of the carbon nanotube-containing dielectric ink 4 being at least partially in contact with the at least one layer 20 of the non-carbon nanotube-containing dielectric ink 2.

In the object 5 formed by an additive manufacturing process described above, the object 5 is one of a printed circuit board and a semiconductor wafer.

In accordance with another form of the present invention, a carbon nanotube-containing dielectric ink 4 and a non-carbon nanotube-containing dielectric ink 2 for use with an inkjet printer 12 in an additive manufacturing process is provided, the carbon nanotube-containing dielectric ink 4 having one or more components which allow the carbon nanotube-containing dielectric ink 4 to be at least one of curable, linkable and reactive with the non-carbon nanotube-containing dielectric ink 2.

In the carbon nanotube-containing dielectric ink 4 and a non-carbon nanotube-containing dielectric ink 2 described above, each of the carbon nanotube-containing dielectric ink 4 and the non-carbon nanotube-containing dielectric ink 2 includes a multi-site monomer.

In the carbon nanotube-containing dielectric ink 4 and a non-carbon nanotube-containing dielectric ink 2 described above, each of the carbon nanotube-containing dielectric ink 4 and the non-carbon nanotube-containing dielectric ink 2 includes an acrylate monomer or polymer that is curable, wherein the acrylate monomer or polymer in the carbon nanotube-containing dielectric ink 4 is cross-linkable to the acrylate monomer or polymer in the non-carbon nanotube-containing dielectric ink 2.

In the carbon nanotube-containing dielectric ink 4 and a non-carbon nanotube-containing dielectric ink 2 described above, each of the carbon nanotube-containing dielectric ink 4 and the non-carbon nanotube-containing dielectric ink 2 includes at least one monomer or polymer, the at least one monomer or polymer of the carbon nanotube-containing dielectric ink 4 being compatible with or the same as the at least one monomer or polymer of the non-carbon nanotube-containing dielectric ink 2.

In accordance with another form of the present invention, a curable carbon nanotube-containing dielectric ink 4 and a curable non-carbon nanotube-containing dielectric ink 2 for use with an inkjet printer 12 in an additive manufacturing process is provided, wherein at least one of the curable carbon nanotube-containing dielectric ink 4 and the curable non-carbon nanotube-containing dielectric ink 2 is one of flexible and rigid when cured.

Although illustrative embodiments of the present disclosure have been described herein with reference to the accompanying drawings, it is to be understood that the disclosure is not limited to those precise embodiments, and that various other changes and modifications may be effected therein by one skilled in the art without departing from the scope or spirit of the disclosure.

1. An additive manufacturing process using an inkjet printer for forming at least one layer of a carbon nanotube-containing dielectric ink and at least one layer of a non-carbon nanotube-containing dielectric ink directly or indirectly on an object, which comprises the steps of:
containing the non-carbon nanotube-containing dielectric ink in a first vessel of the inkjet printer;
supplying the non-carbon nanotube-containing dielectric ink to a first printer head or to a first channel of a multi-channel printer head of the inkjet printer from the first vessel;
applying by the first printer head or the first channel of the multi-channel printer head of the inkjet printer the non-carbon nanotube-containing dielectric ink directly or indirectly to the object to form the at least one layer of the non-carbon nanotube-containing dielectric ink directly or indirectly thereon;
containing the carbon nanotube-containing dielectric ink in a second vessel of the inkjet printer;
supplying the carbon nanotube-containing dielectric ink to a second printer head or to a second channel of the multi-channel printer head of the inkjet printer from the second vessel, wherein the first vessel is not in fluid communication with the second vessel to ensure that the non-carbon nanotube-containing dielectric ink contained in the first vessel is not mixed with the carbon nanotube-containing dielectric ink contained in the second vessel prior to the non-carbon nanotube-containing dielectric ink and the carbon nanotube-containing dielectric ink being supplied to the first printer head or the first channel of the multi-channel printer head and the second printer head or the second channel of the multi-channel printer head, respectively; and
applying by the second printer head or the second channel of the multi-channel printer head of the inkjet printer the carbon nanotube-containing dielectric ink directly or indirectly to the object to form the at least one layer of the carbon nanotube-containing dielectric ink directly or indirectly thereon, the at least one layer of the carbon nanotube-containing dielectric ink being at least partially in contact with the at least one layer of the non-carbon nanotube-containing dielectric ink.

2. An additive manufacturing process as defined by claim 1, wherein the dielectric constant of the non-carbon nanotube-containing dielectric ink is between about 3 and about 4.5.

3. An additive manufacturing process as defined by claim 1, wherein the thickness of the at least one layer of the non-carbon nanotube-containing dielectric ink is between about 5 microns and about 20 microns.

4. An additive manufacturing process as defined by claim 1, wherein the dielectric constant of the carbon nanotube-containing dielectric ink is between about 3 and about 4.5.

5. An additive manufacturing process as defined by claim 1, wherein the thickness of the at least one layer of the carbon nanotube-containing dielectric ink is less than about 3 microns.

6. An additive manufacturing process as defined by claim 1, wherein the thickness of the at least one layer of the carbon nanotube-containing dielectric ink is less than about 1 micron.

7. An additive manufacturing process as defined by claim 1, wherein the at least one layer of the non-carbon nanotube-containing dielectric ink resides directly or indirectly below the at least one layer of the carbon nanotube-containing dielectric ink.

8. An additive manufacturing process as defined by claim 1, wherein the at least one layer of the non-carbon nanotube-containing dielectric ink resides directly or indirectly above the at least one layer of the carbon nanotube-containing dielectric ink.

9. An additive manufacturing process as defined by claim 1, wherein the at least one layer of the non-carbon nanotube-containing dielectric ink includes more than one layer of the non-carbon nanotube-containing dielectric ink, at least one layer of the more than one layer of the non-carbon nanotube-containing dielectric ink being at least partially in contact with the at least one layer of the carbon nanotube-containing dielectric ink.

10. An additive manufacturing process as defined by claim 1, wherein the at least one layer of the carbon nanotube-containing dielectric ink includes more than one layer of the carbon nanotube-containing dielectric ink, at least one layer of the more than one layer of the carbon nanotube-containing dielectric ink being at least partially in contact with the at least one layer of the non-carbon nanotube-containing dielectric ink.

11. An additive manufacturing process as defined by claim 1, wherein the object is one of a printed circuit board and a semiconductor wafer.

12. An inkjet printer used in an additive manufacturing process for applying a carbon nanotube-containing dielectric ink and a non-carbon nanotube-containing dielectric ink directly or indirectly to an object to form respectively at least one layer of the carbon nanotube-containing dielectric ink and at least one layer of the non-carbon nanotube-containing dielectric ink directly or indirectly on the object, which comprises:
a first printer head or a first channel of a multi-channel printer head for applying the non-carbon nanotube-containing dielectric ink directly or indirectly to the object to form the at least one layer of the non-carbon nanotube-containing dielectric ink directly or indirectly thereon;
a first vessel containing the non-carbon nanotube-containing dielectric ink, the first vessel being in fluid communication with the first printer head or with the first channel of the multi-channel printer head for supplying the non-carbon nanotube-containing dielectric ink to the first printer head or to the first channel of the multi-channel printer head;
a second printer head or a second channel of the multi-channel printer head for applying the carbon nanotube-containing dielectric ink directly or indirectly to the object to form the at least one layer of the carbon nanotube-containing dielectric ink directly or indirectly thereon; and
a second vessel containing the carbon nanotube-containing dielectric ink, the second vessel being in fluid communication with the second printer head or with the second channel of the multi-channel printer head for supplying the carbon nanotube-containing dielectric ink to the second printer head or the second channel of the multi-channel printer head;
wherein the first vessel is not in fluid communication with the second vessel to ensure that the non-carbon nanotube-containing dielectric ink contained in the first vessel is not mixed with the carbon nanotube-containing dielectric ink contained in the second vessel prior to the non-carbon nanotube-containing dielectric ink and the carbon nanotube-containing dielectric ink being supplied to the first printer head or the first channel of the multi-channel printer head and the second printer head or the second channel of the multi-channel printer head, respectively.

13. An inkjet printer used in an additive manufacturing process as defined by claim 12, wherein the dielectric constant of the non-carbon nanotube-containing dielectric ink is between about 3 and about 4.5.

14. An inkjet printer used in an additive manufacturing process as defined by claim 12, wherein the thickness of the at least one layer of the non-carbon nanotube-containing dielectric ink is between about 5 microns and about 20 microns.

15. An inkjet printer used in an additive manufacturing process as defined by claim 12, wherein the dielectric constant of the carbon nanotube-containing dielectric ink is between about 3 and about 4.5.

16. An inkjet printer used in an additive manufacturing process as defined by claim 12, wherein the thickness of the at least one layer of the carbon nanotube-containing dielectric ink is less than about 3 microns.

17. An inkjet printer used in an additive manufacturing process as defined by claim 12, wherein the thickness of the at least one layer of the carbon nanotube-containing dielectric ink is less than about 1 micron.

18. An inkjet printer used in an additive manufacturing process as defined by claim 12, wherein the at least one layer of the non-carbon nanotube-containing dielectric ink resides directly or indirectly below the at least one layer of the carbon nanotube-containing dielectric ink.

19. An inkjet printer used in an additive manufacturing process as defined by claim 12, wherein the at least one layer of the non-carbon nanotube-containing dielectric ink resides directly or indirectly above the at least one layer of the carbon nanotube-containing dielectric ink.

20. An inkjet printer used in an additive manufacturing process as defined by claim 12, wherein the at least one layer of the non-carbon nanotube-containing dielectric ink includes more than one layer of the non-carbon nanotube-containing dielectric ink, at least one layer of the more than one layer of the non-carbon nanotube-containing dielectric ink being at least partially in contact with the at least one layer of the carbon nanotube-containing dielectric ink

21. An inkjet printer used in an additive manufacturing process as defined by claim 12, wherein the at least one layer of the carbon nanotube-containing dielectric ink includes more than one layer of the carbon nanotube-containing dielectric ink, at least one layer of the more than one layer of the carbon nanotube-containing dielectric ink being at least partially in contact with the at least one layer of the non-carbon nanotube-containing dielectric ink.

22. An inkjet printer used in an additive manufacturing process as defined by claim 12, wherein the object is one of a printed circuit board and a semiconductor wafer.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)
